(19) United States
(12) Patent Application Publication
(10) Pub. No.: US 2011/0267328 A1
(43) Pub. Date: Nov. 3, 2011

(54) FAILSAFE INTERCONNECT FOR TILED WALL DISPLAY

(76) Inventors: Narayanan Venkatasubramanian, Sahakara Nagar (IN); Durga Venkata Prasad Sreeram, Bangalore (IN)

(21) Appl. No.: 12/980,577

(22) Filed: Dec. 29, 2010

(30) Foreign Application Priority Data
Apr. 28, 2010 (IN) 1182/CHE/2010

(51) Int. Cl. G09G 5/00

(52) U.S. Cl. 345/211

(57) ABSTRACT

A tiled display system includes a plurality of display devices coupled together via a display device interconnect. Video signals and power can be transmitted to any display device coupled to the display device interconnect and then be distributed to the other display devices coupled to the display device interconnect. In situations where the power supply within a display device becomes inactive, the display device is capable of drawing power from neighboring display devices via the display device interconnect in order to power internal circuitry used to relay data signals.

### BACKGROUND OF THE INVENTION

1. Field of the Invention

Embodiments of the present invention generally relate to a display screen used to display an image, and more specifically, a multi-panel display system that is adapted to display images to a large number of viewers.

2. Description of the Related Art

Electronic display systems are commonly used to display information from computers and other sources. Typical display systems range in size from small displays used in mobile devices to very large displays that are used to display images to thousands of viewers at one time. Tiled display walls provide a large-format environment for presenting large high-resolution images by synchronizing and coupling together the output from multiple distinct imaging systems. Such large displays may be created by tiling a plurality of smaller display devices together. For example, the video walls frequently seen in the electronic media typically use multiple display modules, such as flat-panel displays, which are tiled to create such large displays.

FIG. 1A illustrates a tiled wall display 100 configured to display an image 102, according to the prior art. The tiled wall display 100 includes display modules 104-1 through 104-9 that each is configured to display a different portion of the image 102. FIG. 1B illustrates the tiled wall display 100 of FIG. 1A in greater detail. As shown, each display module 104 is coupled to a power source 106, a controller 108, and a video signal source 110. A given display module 104 receives power from the power source 106 via a dedicated power cable 107, receives control signals from the controller 108 via a dedicated control cable 109, and receives a video signal from the video signal source 110 via a dedicated video cable 111. The video cable 111 is typically a rigid, expensive, and heavy digital video interconnect (DVI) cable.

One drawback of this approach is that operation of the tiled wall display 100 requires numerous cables, as illustrated by FIG. 1B, which may receive power from a power supply 126, control signals from a component controller device 124 and video signals from a media player 122. Since each display module receives a power cable 107, control cable 109, and a video cable 111, the tiled wall display 100 must be coupled to at least 27 separate cables in order to function. Such a configuration may be cumbersome to assemble and to maintain, and, additionally, may be difficult to troubleshoot if a malfunction occurs with one of the cables or display modules 104.

As the foregoing illustrates, there is a need in the art for a tiled display device that has a simpler configuration and is less susceptible to failures that prior art designs.

### SUMMARY OF THE INVENTION

Embodiments of the present invention may provide a tiled display system, comprising a first display device configured to generate images for display, comprising a first processing unit configured to receive and to amplify a first data signal, and a first power supply, a second display device coupled to the first display device and configured to generate images for display, comprising a second processing unit configured to receive a data signal, and a second power supply, and a signal box coupled to the first display device and configured to transmit the first data signal to the first display device, wherein the first processing unit is configured to draw power from the second power supply, when the first power supply is unable to supply sufficient power to the first processing unit, so that the first processing unit can transmit the received first data signal to the second display device.

The present invention also provides a method for transmitting an amplified data signal to a display device, comprising transmitting a data signal to a first display device that includes a first power supply, drawing power from a second power supply within a second display device to power an amplifier within the first display device when the first power supply is unable to supply sufficient power, causing the amplifier to generate the amplified data signal, and transmitting the amplified data signal to the second display device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a tiled wall display configured to display an image, according to the prior art;

FIG. 1B illustrates various connections in a tiled wall display configured to display an image, according to the prior art;

FIG. 2 illustrates a tiled display system, according to one embodiment of the invention;

FIG. 3 illustrates a tiled display system, according to one embodiment of the invention;

FIG. 4 illustrates a schematic view of a display screen, according to one embodiment of the invention; and

FIG. 5 is a flowchart of method steps for transmitting an amplified signal, according to one embodiment of the invention.

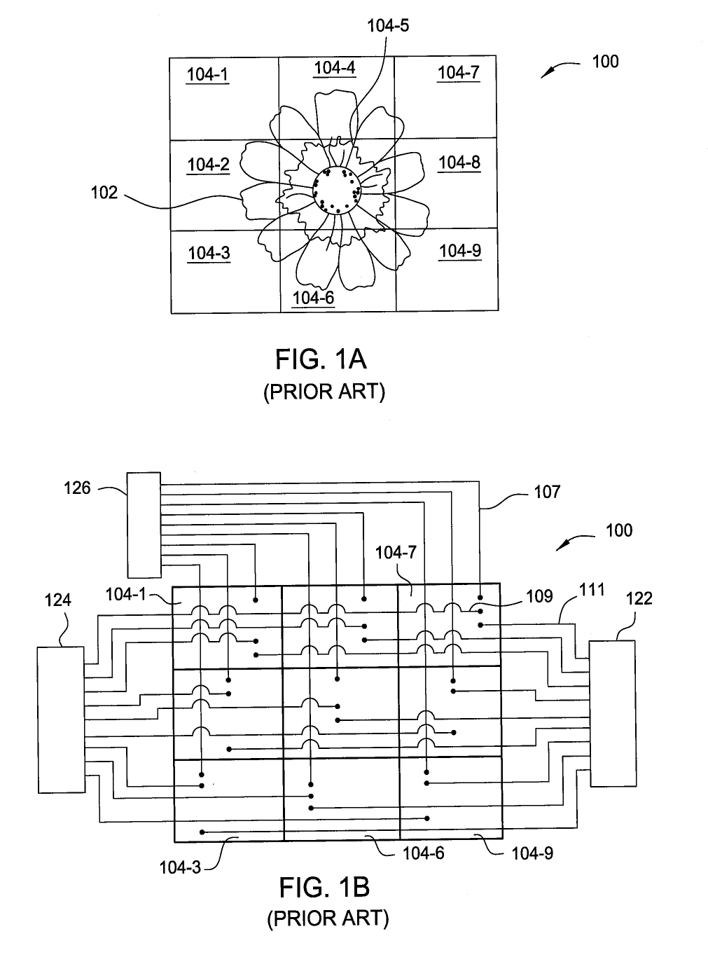

For clarity, identical reference numbers have been used, where applicable, to designate identical elements that are common between figures. It is contemplated that features of one embodiment may be incorporated in other embodiments without further recitation.

### DETAILED DESCRIPTION

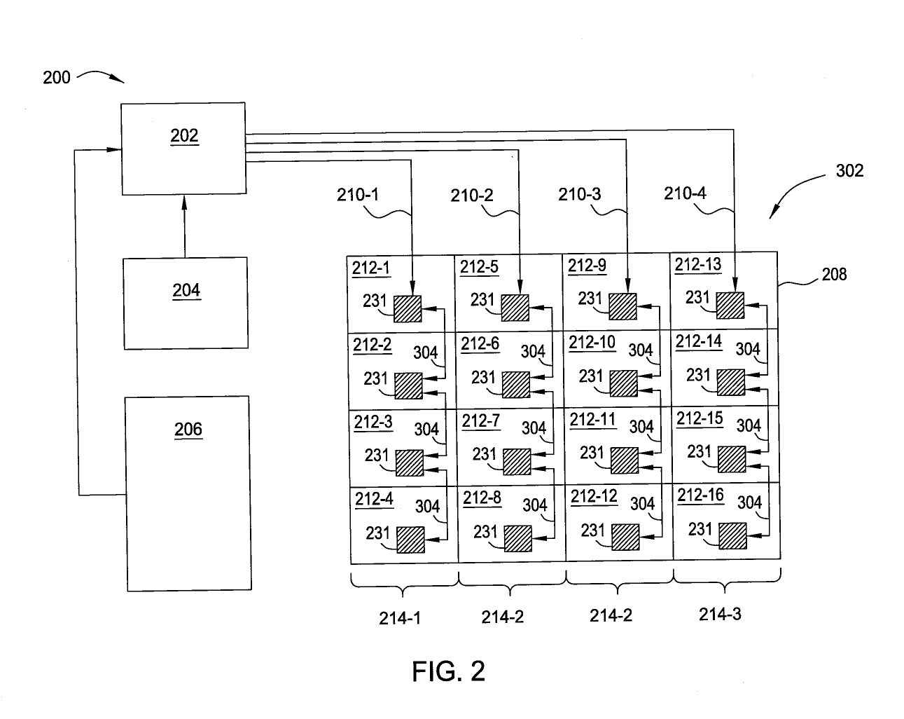

Embodiments of the present invention generally provide a failsafe interconnection configuration between display devices that comprise a tiled display system. The failsafe interconnect provides both video signals, device control signals and power to each display device coupled to the failsafe interconnect. In situations where a display device of the tiled display system is powered down, e.g., due to a power source failure, the display device may draw power via the failsafe interconnect in order to (i) power an internal video processor, (ii) amplify a received video signal for transmission to adjacent display devices, and (iii) amplify the device control signals for transmission to neighboring display devices. FIG. 2 illustrates a tiled display system 200 configured to implement the failsafe interconnect of the present invention.

As shown, the tiled display system 200 includes a signal box (sbox) 202, a media player 204, a computing device 206, and a tiled display screen 208. The media player 204 and the computing device 206 are coupled to the sbox 202. The sbox 202 is coupled to the tiled display screen 208 via sbox interconnects 210-1 through 210-4. In one embodiment, sbox interconnects 210 comprise shielded category-6 (cat-6) cables.

The media player 204 may be any technically feasible media player, such as, for example, a digital video disk (DVD) player, a blu-ray disk (BRD) player or other similar device. The media player 204 is configured to read digital media, such as, e.g., DVDs, and to transmit video data, including image data, to the sbox 202. The computing device 206 may be a personal computer (PC) or any other technically feasible type of computing device. The computing device 206 is generally designed to facilitate the control and automation of the various components found in the display system 200, and typically includes a central processing unit (CPU) (not shown), memory (not shown), and support circuits (or I/O) (not shown). The CPU may be one of any form of computer processors that are used in industrial settings for controlling various components and monitor the state of the various processes. The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the computing device 206 determines which tasks are performable within the display system 200, and are generally used to control, among other components, the sbox 202. The sbox 202, in turn, controls the tiled display screen 208.

The sbox 202 may be a field-programmable gate array (FPGA), a graphics processing unit (GPU), or any other technically feasible image processor. The sbox 202 is configured to process video data received from the media player 204 in response to commands received from the computing device 206. The sbox 202 then transmits data signals to the tiled display screen 208 via the sbox interconnects 210. In one embodiment, the data signals include uncompressed, packetized video data. The sbox 202 may also transmit command data and provide power to the tiled display device 208 via the sbox interconnects 210.

The tiled display screen 208 is configured to display a digital image received from the sbox 202. The digital image may comprise a single frame of video data. The tiled display device 208 includes a plurality of display devices 212-1 through 212-16 that each displays a different portion of the digital image received from the sbox 202. In one embodiment, each display device 212 within a vertical column of the tiled display device 208 is coupled to at least one neighboring display device 212 within the same vertical column via a “display device interconnect” 304, thereby forming an interconnected display column 214. As shown, display devices 212-1 through 212-4 comprise display column 214-1, display devices 212-4 through 212-8 comprise display column 214-2, display devices 212-5 through 212-12 comprise display column 212-3, and display devices 212-13 through 212-16 comprise display column 212-4. While FIGS. 2-4 schematically illustrate the sbox 202 being separate from the tiled display screen 208, or its components, this configuration is not intended to limiting as to the scope of the invention, since one skilled in the art will appreciate that the sbox, or portions thereof, could be attached to or distributed within one or more of the tiled display screen 208 components (e.g., display device 212-1) and still perform the same function(s).

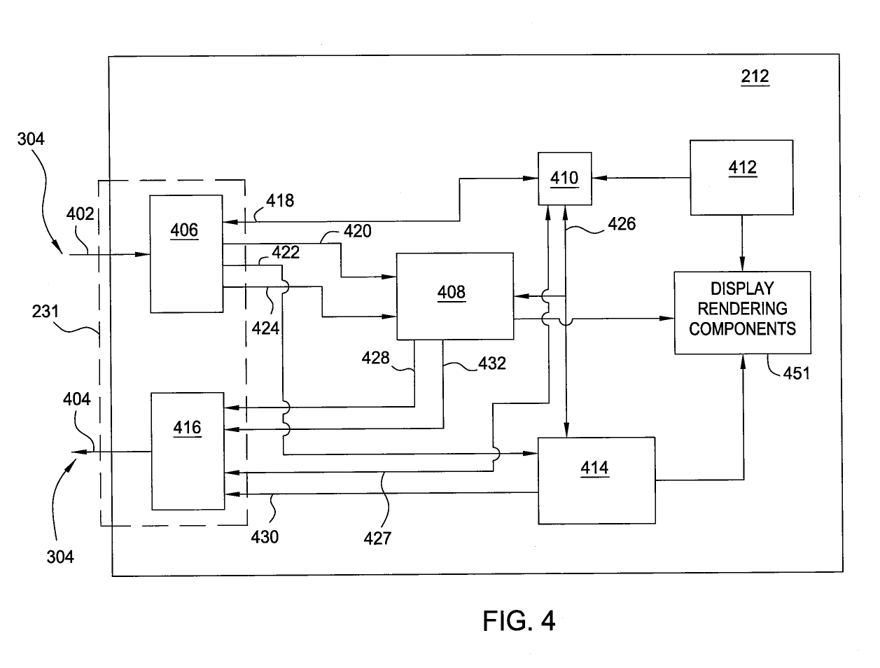

In one embodiment, as illustrated in FIG. 2, a connection point 231 formed on each display device 212 is configured to receive the signal from the sbox 202 via a cable that forms the sbox interconnect 210 and/or a cable that forms the display device interconnect 304. In one example, the connection point 231 on the first display device (e.g., display device 212-1) in each of the display columns (e.g., display column 214-1) are configured to receive an sbox interconnect cable and a display device interconnect cable. In this configuration the signals delivered to the display column from the sbox through the sbox interconnect 210 is then sequentially transferred to each display device 212 in each column via a display device interconnect 304 cable. It should be noted that the connection point 231 may comprise two or more connectors that are used, for example, to receive an incoming signal from an upstream component (e.g., sbox 202 or display device 212-1) through a first connector (e.g., reference 406 in FIG. 4) and deliver an outgoing signal to a downstream display device (e.g., display device 212-2 or display device 212-3) through a second connector (e.g., reference 416 in FIG. 4).

In one embodiment, each display device 212 within a given display column 214 is configured to transmit data signals to neighboring display devices within the column 214 via the display device interconnects 304. The display device interconnects are thus used to interconnect each of the display devices 212. Each display device 212 is also configured to transmit command data and provide power to neighboring display devices within the column 214. For example, the display device 212-3 is coupled to the display devices 212-2 and 212-4, and is configured to transmit data signals to the display devices 212-2 and 212-4 via the display device interconnects 304 between those display devices. The display device 212-3 is further configured to provide power to the display devices 212-2 and 212-4. As referred to herein, “neighboring” display devices constitutes any two or more display devices in a group of interconnected display devices that are electrically coupled together, and thus is not intended to be limited to adjacently connected display devices. Accordingly, in the embodiment illustrated in FIG. 2, each display device 212 within a vertical column 214 can be considered to be “neighbors” of each other within the same vertical column 214. In embodiments where the display devices are arranged differently, for example, in horizontal groupings, the display devices coupled together in a particular group are considered “neighboring” display devices. One skilled in the art will also appreciate that while FIG. 2 illustrates a vertical grouping of display devices, this configuration is not intended to be limiting as to the scope of the invention, since the display devices 212 may be coupled together according in any desired configuration. For example, the display devices 212 could be coupled together to form a plurality of horizontal rows, coupled together in clusters of adjacent displays (e.g., four displays in a 2×2 array), coupled together in a “hub and spoke” configuration, coupled together in a checker-board pattern, or according to some other desired grouping pattern.

In one embodiment, the display device interconnects comprise one or more shielded cat-6 cables coupled to the display devices 214 in a daisy-chain configuration. The sbox 202 is coupled to the display columns 214-1 through 214-4 via the sbox interconnects 210-1 through 210-4, respectively. The sbox 202 may transmit data signals and provide power to the display devices 212 within any display column 214 when coupled to any of the display devices 212 within that display column. For example, the sbox 202 could transmit data signals to the display devices 212-1 through 212-4 within display column 214-1 when coupled only to the display device 214-1 via the sbox interconnect 210-1. With such a configuration, the sbox 202 could transmit data signals to the display device 214-1, which, in turn, could relay the data signals to the display device 214-2 via the display device interconnect. The display device 214-2 could then relay the data signals to the display device 212-3 via the display device interconnect. Finally, the display device 212-3 could relay the data signals to the display device 212-4 via the display device interconnect. In similar fashion, the sbox 202 may provide power to any of the display devices 212 within the column via the display device interconnect.

In other embodiments, each of the display devices 212 is configured to transmit status information to the sbox 202 via the display device interconnect(s) 210 and via any display device interconnect(s) 304 coupled to the intermediate display devices 212. In one configuration, the status information is serially transmitted upstream between serially connected display devices 212 to the sbox 202, via the display device interconnects 304. Additionally, each of the display devices 212 is configured to relay status information received from neighboring, downstream display devices 212 upstream to the sbox 202 via the display device interconnect(s). With this configuration, a given display device 212 may relay all status information received from any downstream display devices 212, as well as its own status information, to the sbox 202 via the display device interconnect. For example, the display device 212-4 may transmit status information to the display device 212-3. The display device 212-3 transmits the received status information, as well as its own status information, to the display device 212-2. The display device 212-2 transmits the received status information (i.e., that associated with the display devices 212-3 and 212-4), as well as its own status information, to the display device 212-1. The display device 212-1 then transmits the received status information (i.e., that associated with the display devices 212-2, 212-3, and 212-4), as well as its own status information, to the sbox 202. In this fashion, the sbox 202 can receive status information from all of the display devices 212 via the display device interconnect.

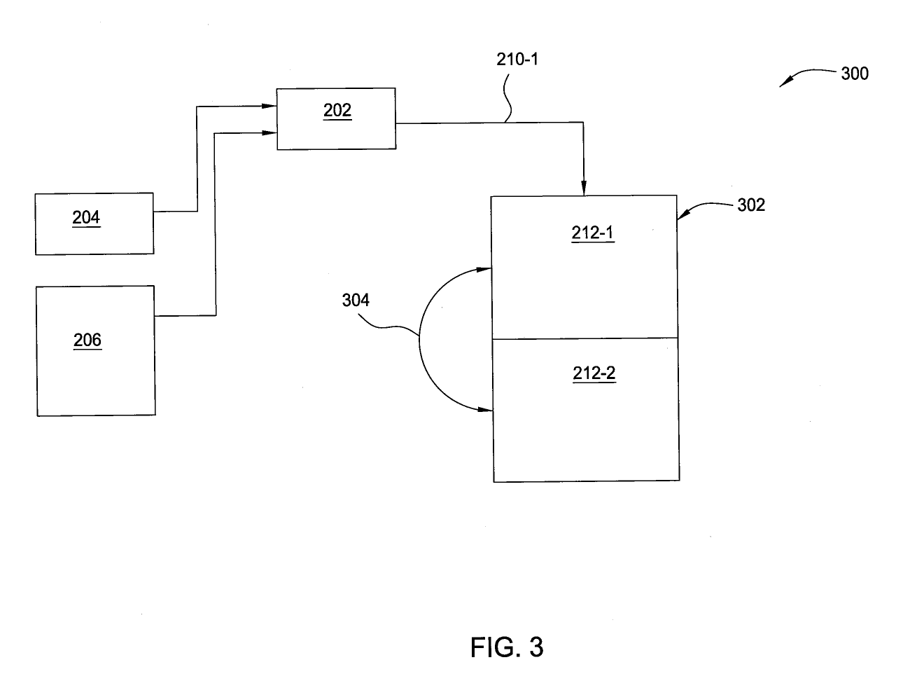

As described in greater detail in FIGS. 3-4, each display device 212 includes a power supply used to power a processing unit within the display device 212. The processing unit is configured to receive data signals and to relay those data signals to neighboring display devices 212. In situations where the power supply in a display device becomes inactive, for example, due to an equipment failure, among other things, components in the display device 212 are configured to draw power from neighboring display devices through a display device interconnect 304 in order to relay the data signals to other neighboring display devices 212. In one embodiment, the processing unit within a given display device 212 receives data signals, amplifies the data signals, and transmits, or relays, the amplified data signals to neighboring display devices. In one example, an inactive intermediate display devices 212-1 (FIG. 2) is disposed between the sbox 202 and an active display device 212-2, and a second inactive intermediate display devices 212-3 is disposed between the first active display device 212-2 and a second active display device 212-4, wherein the sbox 202, the intermediate display devices 212-1, first active display devices 212-2, the intermediate display devices 212-3 and the second active display device 212-4 are each coupled together serially by an interconnect 210 and plurality of interconnects 304, as illustrated in FIG. 2, so that power and data signals can be delivered from the sbox 202 to the first active display device 212-2 and from the first active display device 212-2 to the second active display device 212-4 through the intermediate display devices 212-1, 212-3.

In another embodiment, the display device interconnection scheme is formed so that the connections radiate from a single input point, such as one display device 212 is used to connect all neighboring display devices 212. For example, display device 212-6 could be coupled to display devices 212-1, 212-2, 212-3, 212-5, 212-7, 212-9, 212-10, and 212-11. With this configuration, the sbox 202 need only be coupled to one of the display devices 212 in order to transmit data signals and command data and provide power to the tiled display system 208.

In another embodiment, the tiled display system 200 includes a second sbox that is coupled to the sbox 202, the media player 204, and the computing device 206. The second sbox is also coupled to a second tiled display screen. The second tiled display screen may be substantially similar to the tiled display screen 208 and may act in conjunction with the tiled display screen 208 to display a single image. With this configuration, the sbox 202 acts as a “master” unit, while the second sbox acts as a “slave” unit. The display devices within the second tiled display screen may or may not be coupled to those within the tiled display screen 208 via the display device interconnect.

Those skilled in the art will recognize that the present invention may be embodied by numerous other configurations of components, including any number of sboxes, tiled display screens, and displace devices. For the sake of simplicity, the remainder of this disclosure will be directed towards a simplified configuration of components, as shown in FIG. 3.

FIG. 3 illustrates a tiled display system 300, according to one embodiment of the invention. The tiled display system 300 represents a simplified version of the tiled display system 200 illustrated in FIG. 2. As shown, the tiled display system 300 includes the sbox 202, the media player 204, the computing device 206, and a tiled display screen 302. In one example, a portion of the tiled display screen 302 includes display devices 212-1 and 212-2 that are disposed within a single display column. The sbox 202 is coupled to the display device 212-1 via the sbox interconnect 210-1. The display devices 212-1 and 212-2 are coupled together via a display device interconnect 304. In general, the interconnects 210-1 and 304 each comprises a plurality of conductive elements, such as wires, across which data signals and power can be transmitted bi-directionally. In one embodiment, the conductive elements within the interconnects 210 and 304 are twisted wire pairs that allow power and/or different types signals to be propagated along its length. In one example, the interconnects 210 and 304 comprise cat-6 cables. The different types of signals may include low-voltage differential signaling (LVDS) signals, command mode logic (CML) signals, and universal asynchronous receiver/transceiver (UART) signals, among others. The power conducted across the twisted wire pairs may be alternating current (AC) or direct current (DC). In one example, the power delivered across one of the twisted wire pairs is delivered at a voltage of ±5 volts DC. In another example, the power delivered across one of the twisted wire pairs is delivered at a voltage of between about 0 and about 12 volts DC. Each twisted wire pair may be shielded (e.g., enclosed in grounded foil or braided wire) to prevent interference, and the all of the twisted wire pairs in each of the interconnects 210 and 304 may each be shielded as a whole. In one embodiment, the display device interconnect 304 comprises a shielded cat-6 cable.

As described above in conjunction with FIG. 2, the media player 204 is configured to read digital media and to transmit video data, including image data, to the sbox 202. The sbox 202 is configured to process video data received from the media player 204 in response to commands received from the computing device 206. The sbox 202 then transmits data signals to the tiled display screen 302 via the sbox interconnect 210. The sbox 202 may also provide power to the tiled display screen 302 via the sbox interconnect 210-1. The tiled display screen 302 is configured to display a digital image received from the sbox 202. The digital image may comprise a single frame of video data. The display devices 212-1 and 212-2 each displays a different portion of the digital image received from the sbox 202. The display devices 212-1 and 212-2 are configured to exchange data signals, command data, and power via the display device interconnect 304.

In one embodiment, the sbox 202 assigns each display device 212 a unique address that can be used to transmit data packets to that display device 212. The sbox 202 then multiplexes data packets that target either of the display devices 212 connected to the sbox interconnect 210 and the display device interconnect(s) 304. The sbox 202 multiplexes the data packets in order to cause the efficient transfer of the data packets to each of the specific display devices 212. In a further embodiment, the data packets comprise uncompressed, packetized video data. In general, the uncompressed data packets are (i) more robust against signal interference due to noise, and (ii) provide higher quality data than compressed data packets.

In another embodiment, the sbox 202 performs diagnostic subroutines on the display devices 212. In doing so, the sbox 202 may access a single display device 212 through the formed sbox interconnect 210 and display device interconnect 304 connections, in order to troubleshoot the display device. The sbox 202 may also perform an alignment procedure that involves some or all of the display devices 212. When performing the alignment procedure, an external sensing device may be coupled to the tiled display device 302 in order to provide alignment feedback to the sbox 202. Based on the alignment feedback, the sbox 202 performs the alignment procedure with the display devices 212. In yet another embodiment, the sbox 202 updates firmware internal to each display device 212 via the sbox interconnect 210 and the display device interconnect 304.

As discussed above in conjunction with FIG. 2, each of the display devices 212 is configured to transmit status information to the sbox 202 via the display device interconnect 304 and via any intermediate display devices 212. In one configuration illustrated in FIG. 3, the display device 212-2 may transmit status information to the display device 212-1, which, in turn, transmits the received status information, as well as its own status information, to the sbox 202. In one embodiment, the display device 212-1 transmits its own status information, as well as any status information received from any downstream display devices (e.g., display device 212-2), when a read command is received from the sbox 202. The status information may be accessed by the sbox 202 when performing diagnostic subroutines, and, thus, may include information associated with the “health,” or “state,” of a given display device 212. In one embodiment, the status information comprises an LVDS signal. In one embodiment, the status information comprises an LVDS signal that is used in combination with a heart beat, or strobe signal, to ensure the timely collection of relevant data about each display device.

As described in greater detail below in conjunction with FIG. 4, each display device 212 shown in FIGS. 2-3 includes at least one processing unit that may receive power from a power supply. In one example, under nominal operating conditions, the processing unit within display device 212-1 draws power from the power supply in order to (i) perform processing operations associated with a data signal received from the sbox 202, and (ii) relay the data signal to neighboring display devices, such as between display devices 212-1 and 212-2. As noted above, “neighboring” display devices refers to any two or more display devices coupled together via the interconnect 210 and/or display device interconnect 304. As also noted above, in some cases the received data signal may be amplified before it is relayed to a neighboring display device.

In situations where the power source associated with the display device 212-1 becomes inactive, for example, due to an equipment failure within the display device 212-1, the processing unit within the display device 212-1 may (i) draw power from the sbox 202 via the sbox interconnect 210 and/or (ii) draw power from the neighboring display device (e.g., display device 212-2) in order to provide power to the processing unit. For example, the processing unit within the display device 212-1 may then relay the data signal to the display device 212-2. In one embodiment, one or more display devices 212 that have an inactive power supply may draw power from a power supply coupled to one of the other display devices 212.

By implementing the display device interconnect 304, as described herein, the display device 212-1 is able to relay the data signal received from the sbox 202, despite being coupled to an inactive power supply, by use of the extra power delivered from the sbox and/or neighboring display devices.

In one embodiment, a single display device 212 is capable of powering a processing unit within that display device 212 as well as powering the processing unit within one neighboring display device. In one example, about half of the neighboring display devices may have inactive power supplies and may draw power from the active power supplies within the other half of the neighboring display devices. In another embodiment, a single display device 212 is capable of powering the processing unit within the display device 212 as well as powering all of the processing units within any of the display devices coupled to that display device 212. Referring to FIG. 2, in one example, a functioning display device 212-4 that is disposed at the end, or near the end, of a series of interconnected display devices 212-1, 212-2, 212-3, 212-4 may be configured to deliver enough power to the processing units in all of the damaged up-stream devices 212-1, 212-2, 212-3 to allow the signal delivered from the sbox 202 to be delivered to the display device 212-4 so that an image can be processed for display.

FIG. 4 illustrates a schematic view of the display device 212, according to one embodiment of the invention. The display device 212 may be any of the display devices 212 illustrated in FIGS. 2-3. As shown, the display device 212 receives input and/or transmits output via an input/output (IO) link 402. The display device 212 also provides receives input and/or transmits output via IO link 404. In one embodiment, the IO link 402 and the IO link 404 are shielded cat-6 cables. The cat-6 cables provide a higher data rate and a higher signal-to-noise ratio than conventional cables, such as category-5 (cat-5) cables.

The IO link 402 may be coupled to the sbox 202 via the sbox interconnect 210 shown in FIG. 3. The IO link 402 and the IO link 404 may be part of a display device interconnect 304 that is used to interconnect the display devices, as shown in FIGS. 3 and 4. The display device 212 may receive/send data signals, command signals, and power via the IO links 402 and 404.

The display device 212 includes connectors 406 and 416 that are positioned in the connection point 231, a processing unit 408, a power isolation unit 410, a power supply 412, a processing unit 414 and various display rendering components 451. In one embodiment, the power supply 412 is located external to the display device 212. The display rendering components are generally used to receive the video and control signal data sent along the IO links 402 and 404 to process image data for display. In one embodiment, the display device 212 displays image data using a laser-based display system. An example of laser based display rendering components that may be used in combination with one or more of the embodiments described herein is further described in the commonly assigned published United States Patent Application No. 20060221021, which is herein incorporated by reference in its entirety.

In one embodiment of the display system, the connectors 406 and 416 are cat-6 type connectors. The connector 406 is coupled to the power isolation unit 410 via a power link 418. The power supply 412 is also coupled to the power isolation unit 410, which is coupled to the processing unit 408 and the processing unit 414 via the power link 426. The power supply 412 is generally configured, while functioning properly, to deliver power to the components in the display device 212 and the power links 418, 426, and 427. The power links 418 and 427 and portions of the display device interconnect(s) 304 form a power bus that is used to share power between the interconnected display devices. In one embodiment, the power links 418 and 427 may conduct power bi-directionally to and from the power isolation unit 410, allowing the power isolation unit 410 to receive power from or conduct power to either of the power links 418 and 427 and, thus, any other components coupled to those power links.

The processing unit 408 may be an FPGA, a GPU, or any other technically feasible video processor. In one embodiment, the processing unit 408 includes an active data receiver and retimed transmitter. The processing unit 408 receives data signals via signal link 424 and strobe link 420. The processing unit 408 samples the data signals and performs processing operations with video data included in the data signals to generate a digital image for display. The processing unit 408 is also configured to relay the data signals to the IO link 404 via strobe link 428 and/or the signal link 432. In some situations, the processing unit 408 may be configured to amplify the data signals prior to relaying those data signals to the IO link 404. In one embodiment, signal links 424 and 432 are video data links and the processing unit 408 transmits amplified data signals across signal link 432.

The processing unit 414 may be a central processing unit (CPU), an integrated circuit (IC), or any other technically feasible processing unit. In one embodiment, the processing unit 414 includes an active control propagator. In another embodiment, the processing unit 414 includes a microcontroller. The processing unit 414 receives command signals via the command link 422 and performs operations to coordinate the operation of the display device 212 based on the received command signals. The processing unit 414 then transmits the command signals to the IO link 404 via command link 430. In one embodiment, the command signals include universal asynchronous receive/transmit (UART) signals, and the processing unit 414 includes a UART microcontroller.

Under nominal operating conditions, the processing unit 408 and the processing unit 414 each draws power from the power isolation unit 410, which, in turn, draws power from the power supply 412. However, under certain circumstances, the power supply 412 may be inactive, for example, due to an equipment failure. When the power supply 412 is inactive, the power isolation unit 410 channels power from neighboring display device(s) or the sbox through the power link 418 and/or the power link 426 and provides the power to the processing unit 408 and to the processing unit 414. The power isolation unit 410 is also configured to electrically isolate the power supply 412 from the power links 418, 426, and 427. In doing so, the power isolation unit 410 prevents the inactive power supply 412 from pulling the power links 418, 426, and 427 low. By implementing this approach, a display device 212 with an inactive power supply can draw sufficient power to relay received data signals to neighboring display devices 212.

In general, the power supply 412 is capable of powering the processing unit 408, the processing unit 414, and the display rendering components 451, as well as powering processing units within at least one neighboring display device. With such a configuration, a display device 212 with an inactive power supply can continue to relay received data signals when coupled to a display device 212 that has an active power supply via the display device interconnect 304. In one embodiment, within a group of neighboring display devices, each display device can relay signals to the neighboring display devices as long as the number of display devices 212 with functioning power supplies is greater than or equal to the number of display devices 212 with non-functioning power supplies. In another embodiment, the power supply 412 is capable of powering some or all of the circuitry within any number of neighboring display devices 212. In one example, the power supply 412 is configured to deliver at least about 1 Watt of power for each device that it is positioned within the desired interconnected group of display devices (e.g., display devices in each display column 214-1, 214-2, 214-3, or 214-4 in FIG. 2). In some cases, where small gauge wires (e.g., 22-24 AWG copper wires) are used in the interconnect 210 and/or display device interconnect 304 cables, such as in the case where cat-6 cables are used, it is desirable to limit the amount of power transferred through the wires in the cable to 15 Watts or less to prevent over heating of the wires and shielding, which may cause connection reliability problems and/or create a fire hazard. In another embodiment, it is desirable to limit the amount of power transferred through the wires in the cable to 10 Watts or less.

In one embodiment, when the power supply 412 is electrically isolated by the power isolation unit 410, and the power links 418 and/or 427 are coupled to the display device interconnect 304, the power links 418 and 427 may act as a portion of the power bus. The power bus includes the display device interconnect 304 shown in FIG. 3 as well as any power links 418 and 427 within each display device 212 coupled to the display device interconnect 304. The power bus is configured to provide a common source of power from which the components inside any of the interconnected display devices 212 may draw power, such as the processing unit 408 and the processing unit 414. When functioning, the power supply 412 provides power to the power bus. When not functioning, the power isolation unit 410 isolates the non-functioning power supply 412 from the power bus to prevent the power supply 412 from pulling the power bus low. The power supplies in neighboring display devices can thus be used to provide power to the desired components in the damaged display device 212 to allow the transfer of the video and control data through the damaged display device. In another embodiment, the power isolation unit 410 isolates the power bus from the functioning power supply 412, which powers the power links 426, which channels power to the processing unit 408 and the processing unit 414. One skilled in the art will appreciate that the power isolation unit 410 may comprise conventional DC power isolation components that can be configured to minimize or prevent the current flow from the power bus to the failed power supply 412 and/or other internally connected components.

In one embodiment, the power bus, which is connected to the power isolation unit 410, provides an amount of power sufficient to drive an amplifier, controller or signal propagator within the processing unit 408, thereby enabling the processing unit 408 to amplify received data signals and transmit the amplified data signals to the output 404 via the connector 416. In another embodiment, the power isolation unit 410 provides an amount of power sufficient to drive both the processing unit 408 and the processing unit 414.

By implementing the configuration of components described above, the display device 212 is capable of (i) receiving and transmitting data signals and power via the 10 links 402 and/or 404, and (ii) providing sufficient power to the processing unit 408 such that the processing unit 408 is capable of amplifying and transmitting a received data signal to neighboring display devices.

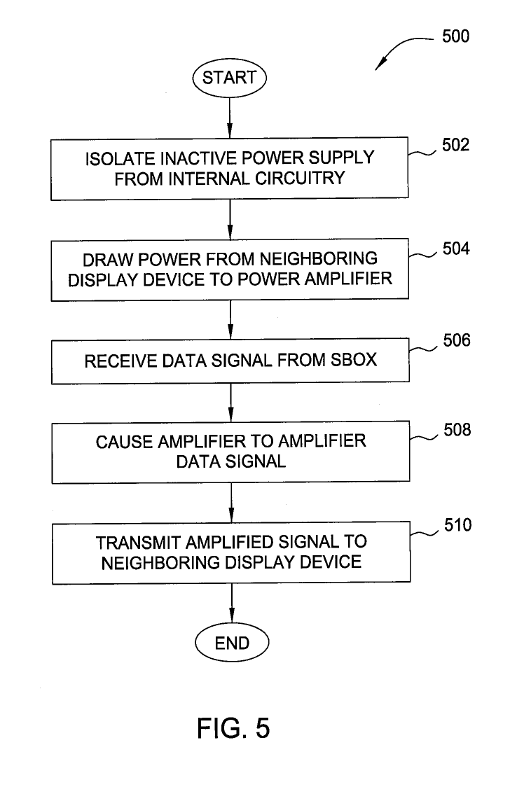

FIG. 5 is a flowchart of method steps for transmitting an amplified signal, according to one embodiment of the invention. Although the method steps are described in conjunction with the systems of FIG. 4, persons skilled in the art will understand that any system configured to perform the method steps, in any order, is within the scope of the invention.

As shown, the method 500 begins at step 502, where the power isolation unit 410 within the display device 212 electrically isolates the internal power supply 412 from internal circuitry within the display device 212. The internal circuitry may generally include a processing unit 408 and a processing unit 414. The power isolation unit 410 electrically isolates the internal power supply 412 from the power links 418, 426, and 427 in order to prevent the inactive power supply 412 from pulling the power links 418, 426, and 427 low.

At step 504, the power bus connected to the power isolation unit 410 draws power from one or more neighboring display devices in order to power processing unit 408 and/or processing unit 414. In this configuration, the power is delivered to the power bus, since it is coupled to the neighboring display device via the display device interconnect 304 and/or sbox interconnect 210.

At step 506, the processing unit 408 within the display device 212 receives a data signal from the sbox 202. The display device 212 may receive the data signal via the sbox interconnect 210, or, alternatively, via the display device interconnect 304. The data signal may comprise one or more packets of uncompressed, multiplexed video data.

At step 508, the processing components in the display device 212 that remain active due to the delivery of power from the power bus, cause the amplifier within the processing unit 408 and/or processing unit 414 to amplify their respective received data signal.

At step 510, the processing unit 408 within the display device 212 transmits the amplified data signal to a neighboring display device via the display device interconnect. The active neighboring display device(s) may also provide power to other interconnected display devices that are inoperative or damaged using the various steps 502-510 described above. Once all of the data has been received by all of the interconnected devices the method 500 may end.

In sum, a tiled displayed system includes a plurality of display devices that each displays a different portion of an image. Each display device is coupled to one or more neighboring display devices in order to exchange power and data signals. When the power supply within a given display device becomes inactive, e.g., due to an equipment failure, the display device is capable of drawing sufficient power from the neighboring display devices to power a video processor within the display device. Upon receiving the data signal, the video processor samples the data signal using the power drawn from the neighboring display devices. The video processor then amplifies the data signal for transmission to the neighboring display devices.

Advantageously, coupling together neighboring display devices and transmitting video data and power between those neighboring devices decreases the total number of cables required to transmit video data to the display devices within the tiled display system. In situations where the power supply within a given display device fails, the display device still is capable of relaying a received video signal using power drawn from neighboring display devices. In addition, the cabling used to transmit the video data to the tiled display system and between the display devices is highly flexible, shielded cat-6 cable. This feature makes the assembly and maintenance of the tiled display system less difficult than conventional systems. Lastly, since shielded cat-6 cables are highly available compared to DVI cables, faulty cables may be replaced easily.

While the foregoing is directed to embodiments of the present invention, other and further embodiments of the invention may be devised without departing from the basic scope thereof, and the scope thereof is determined by the claims that follow.

We claim:

1. A tiled display system, comprising:
a first display device configured to generate images for display, comprising a first processing unit configured to receive a first data signal;
a first power supply coupled to the first processing unit;
a second display device coupled to the first display device and configured to generate images for display, comprising a second processing unit configured to receive at least a portion of the first data signal;
a second power supply coupled to the second processing unit; and
a signal box coupled to the first display device and configured to transmit the first data signal to the first display device, wherein the first processing unit is configured to draw power from the second power supply, when the first power supply is unable to supply sufficient power to the first processing unit, so that the first processing unit can relay the received first data signal to the second display device.

2. The tiled display system of claim 1, wherein the first display device further includes a power isolation unit configured to electrically isolate the first power supply from the first processing unit when the first power supply is unable to supply sufficient power to the first processing unit.

3. The tiled display system of claim 1, wherein the signal box is coupled to the first display device by a first interconnect that is configured to conduct the first data signal and power to the first display device.

4. The tiled display system of claim 3, wherein the first display device is coupled to the second display device by a second interconnect that is configured to conduct the at least a portion of the first data signal and power to the second display device.

5. The tiled display system of claim 4, wherein the signal box is configured to perform diagnostic subroutines and firmware updates with the first display device via the first interconnect.

6. The tiled display system of claim 5, wherein the signal box is coupled to the second display device via the first interconnect, the first display device, and the second interconnect, and wherein the signal box is configured to perform diagnostic subroutines and firmware updates with the second display device via the first interconnect, the first display device, and the second interconnect.

7. The tiled display system of claim 6, wherein the signal box is configured to perform an alignment procedure with the first display device and the second display device.

8. The tiled display system of claim 1, wherein the signal box and the first display device, or the first display device and the second display device, are electrically coupled together via a cable that comprises:
a first twisted wire pair that comprises a first and a second wire that are shielded, wherein the first twisted wire pair is configured to conduct power;
a second twisted wire pair that comprises a first and a second wire that are shielded, wherein the second twisted wire pair is configured to conduct a low-voltage differential signaling signal;
a third twisted wire pair that comprises a first and a second wire that are shielded, wherein the third twisted wire pair is configured to conduct a universal receiver/transceiver signal; and
a fourth twisted wire pair that comprises a first and a second wire that are shielded, wherein the fourth twisted wire pair is configured to conduct a command mode logic signal.

9. The tiled display system of claim 1, wherein the first data signal comprises packetized, uncompressed, multiplexed video data, the first display device generates images for display based on the first data signal, and the second display device generates images for display based on the first data signal.

10. The tiled display system of claim 1, wherein the first processing unit and the second processing unit each comprises a field-programmable gate array.

11. The tiled display system of claim 1, wherein a connection formed between the first display device and the signal box, or the first display device and the second display device, comprises at least one intermediate display device through which the first data signal is relayed.

12. The tiled display system of claim 1, wherein one or more intermediate display devices are disposed between the signal box and the first display device, or between the second display device and the first display device, wherein the first display device, the second display device, the signal box and the one or more intermediate display devices are each coupled together serially by an interconnect.

13. A method for transmitting a data signal to a display device, comprising:
transmitting a first data signal to a first display device that includes a first power supply;
drawing power from a second power supply within a second display device to power a processing unit within the first display device when the first power supply is unable to supply sufficient power;
causing the processing unit to relay at least a portion of the first data signal to the second display device.

14. The method of claim 13, further comprising the step of electrically isolating the first power supply from the processing unit when drawing power from the second power supply.

15. The method of claim 13, wherein the step of transmitting the first data signal to the first display device comprises transmitting the first data signal across a first interconnect coupled to the first display device, wherein the first interconnect is configured to conduct data signals and power.

16. The method of claim 15, wherein the step of relaying at least a portion of the first data signal to the second display device comprises transmitting at least a portion of the first data signal across a second interconnect coupled to the first display device and the second display device, wherein the second interconnect is configured to conduct data signals and power.

17. The method of claim 16, further comprising the steps of performing diagnostic subroutines and firmware updates with the first display device via the first interconnect.

18. The method of claim 17, further comprising the steps of performing diagnostic subroutines and firmware updates with the second display device via the first interconnect, the first display device, and the second interconnect.

19. The method of claim 18, further comprising the steps of performing an alignment procedure with the first display device and the second display device.

20. The method of claim 13 wherein signal box, the first display device, and the second display device are each electrically coupled together via a category-6 cable, and wherein the category-6 cable is configured to conduct data signals and power between the signal box, the first display device, and the second display device.

21. The method of claim 20, wherein the category-6 cable comprises:
a first twisted wire pair that comprises a first and a second wire that are shielded, wherein the first twisted wire pair is configured to conduct power;
a second twisted wire pair that comprises a first and a second wire that are shielded, wherein the second twisted wire pair is configured to conduct a low-voltage differential signaling signal;
a third twisted wire pair that comprises a first and a second wire that are shielded, wherein the third twisted wire pair is configured to conduct a universal receiver/transceiver signal; and
a fourth twisted wire pair that comprises a first and a second wire that are shielded, wherein the fourth twisted wire pair is configured to conduct a command mode logic signal.

22. The method of claim 13, wherein the first data signal comprises packetized, uncompressed, multiplexed video data, the first display device generates images for display based on the first data signal, and the second display device generates images for display based on at least a portion of the first data signal.

23. The method of claim 13, wherein the first display device and the second display device each includes a field-programmable gate array.

24. The method of claim 13, wherein the relayed portion of the first data signal is configured to pass through a processing unit disposed in at least one intermediate display device that is disposed between the first and second display devices.

25. The method of claim 13, wherein one or more intermediate display devices are disposed between the signal box and the first display device, or between the second display device and the first display device, wherein the first display device, the second display device, the signal box and the one or more intermediate display devices are each coupled together serially by an interconnect.
